(19) United States
(12) Patent Application Publication
(10) Pub. No.: US 2013/0264993 A1
(43) Pub. Date: Oct. 10, 2013

(54) SPEAKER DEVICE PROVIDING BACKUP POWER

(71) Applicant: Ching-Ling CHOU, New Taipei City (TW)

(72) Inventor: Ching-Ling CHOU, New Taipei City (TW)

(21) Appl. No.: 13/441,446

(22) Filed: Apr. 6, 2012

(51) Int. Cl. H02J 7/00

(52) U.S. Cl. 320/103

(57) ABSTRACT

A speaker device providing backup power includes a main body, at least one speaker unit and at least two power-storing units. The main body includes a charging port for electrically connecting to an external power source, an audio port for connecting to a portable electronic device, a discharging port for electrically connecting to the portable electronic device, and a control circuit unit for connecting to the charging port, audio port and discharging port. The speaker unit is electrically connected to the control circuit unit to obtain audio signal via the audio port. The two power-storing units store power from the external power source, and include a first power-storing unit for driving the speaker unit and a second power-storing unit for electrically connecting to the discharging port to allow charging power stored in the second power-storing unit to charge into the portable electronic device connected to the discharging port.

### FIELD OF THE INVENTION

The present invention relates to a portable speaker device, and particularly to a portable speaker device providing backup power.

### BACKGROUND OF THE INVENTION

As technologies continue to evolve, multimedia technologies have developed from earlier televisions and sound systems to later MD walkmans, CD walkmans, VCD players and DVD players and to current MP3 portable discs, tablet computers and smart phones. It is observed that miniaturization and compact designs for electronic devices are a common goal of researchers and developers of associated industries. Along with vigorous progress of hardware techniques, functions of electronic devices are no longer limited to as simple as electronic books and 2G communications. In contrast, sophisticated functions including multimedia playback, GPS navigation, document processing and wireless networking can all be achieved by current electronic devices. However, power consumption for realizing the diversified functions above increases as a result.

In response to the increase in power consumption, the amount of electric energy in an electronic device is boosted through an improved rechargeable battery or a rechargeable battery with an increased number of battery cells, so as to prolong a utilization period or a standby period of the electronic device. Yet, the increased number of battery cells of a rechargeable battery inevitably enlarges the size of an electronic device, inferring that such approach is infeasible in an electronic device that requires a user-demanded compact design.

To mitigate the above issue, mobile power supplies have been developed. Through a portable power supply, an electronic device can be powered by a backup power supply when a power level of the electronic device is low.

Further, to enhance audio effects of multimedia playback of an electronic device, a sound device supporting multimedia playback of the electronic device is also market-available. Such additional equipment again adds a space requirement to the electronic device as well as a portability issue to the sound device.

In view of the above problems, R.O.C. Patent No. M292234 discloses a portable speaker and charging apparatus for a multimedia player. The prior art is to provide a speaker and charging apparatus with power storage and power supply functions to solve complications of having to connect to an external power source for a conventional externally connected speaker and charging apparatus, thereby offering greater flexibilities with respect to utilization space and circumstances. When the disclosed speaker and charging apparatus is connected to an electronic device, a power supply module (i.e., a charging battery) needs to concurrently power the electronic device and the speaker device. Consequently, an unstable power supply is likely resulted to lead to unsatisfactory playback effects of the speaker device or even to incur damages and shortened lifespan of the electronic device.

### SUMMARY OF THE INVENTION

Therefore the primary object of the present invention is to solve the aforesaid disadvantages. As previously stated, in a conventional portable multimedia device, an electronic device and a speaker device are at the same time powered by a single charging battery, such that an unstable power supply is likely resulted to lead to unsatisfactory playback effects of the speaker device or even to incur damages and shortened lifespan of the electronic device.

To achieve the foregoing object, the present invention provides a speaker device providing backup power that includes a main body, at least one speaker unit and at least two power-storing units. The main body, having an internal installation space, includes a charging port for electrically connecting to an external power source, an audio port for connecting to a portable electronic device to obtain an audio signal, and a discharging port for electrically connecting to the portable electronic device. In the installation space of the main body, the main body further includes a control circuit unit connected to the charging port, the audio port and the discharging port. The speaker unit is disposed in the installation space, and is electrically connected to the control circuit unit to obtain the audio signal of the portable electronic device via the audio port. The power-storing units are disposed in the installation space, and are electrically connected to the control circuit unit to obtain charging power of the external power source. The power-storing units include a first power-storing unit and a second power-storing unit. The first power-storing unit is electrically connected to the speaker unit to drive the speaker unit. The second power-storing unit is electrically connected to the discharging port to allow the charging power stored in the second power-storing unit to charge into the portable electronic device connected to the discharging port.

The control circuit unit further includes a monitoring circuit electrically connected to the first power-storing unit and the second power-storing unit. The monitoring circuit includes a power-controlled signal, which prompts the second power-storing unit to charge the first power-storing unit when an output voltage of the first power-storing unit is lower than a predetermined voltage value.

The main body includes two half parts. The half parts may be moved relative to each other to form a coupled state and a used state.

The main body further includes an operation section for controlling the speaker unit.

The main body further includes a display section, which displays a charging status of the second power-storing unit to the portable electronic device or a charging status of the second power-storing unit to the first power-storing unit.

The charging port and the discharging port may be a single shared input/output port.

Therefore, by use of the first power-storing unit and the second power-storing unit of the present invention, the portable electronic device and the speaker unit are respectively provided with an independent power supply, thereby eliminating the issue of uneven or unstable power distributed from a same power supply shared by the electronic device and a speaker device as in the prior art. Further, through the second power-storing unit serving as the backup power supply for the first power-storing unit, it is ensured that charging power is provided by the second power-storing unit to the first power-storing unit when the first power-storing unit has a power shortage, so as to maintain satisfactory playback effects of the speaker unit.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a speaker device providing backup power of the present invention.

FIG. 2 is a perspective view of a speaker device providing backup power of the present invention.

FIGS. 3 and 4 are exploded views of a speaker device providing backup power of the present invention.

FIG. 5 is a schematic view showing a charging status of a speaker device providing backup power of the present invention.

### DETAILED DESCRIPTION OF THE PREFERRED EMBODIMENTS

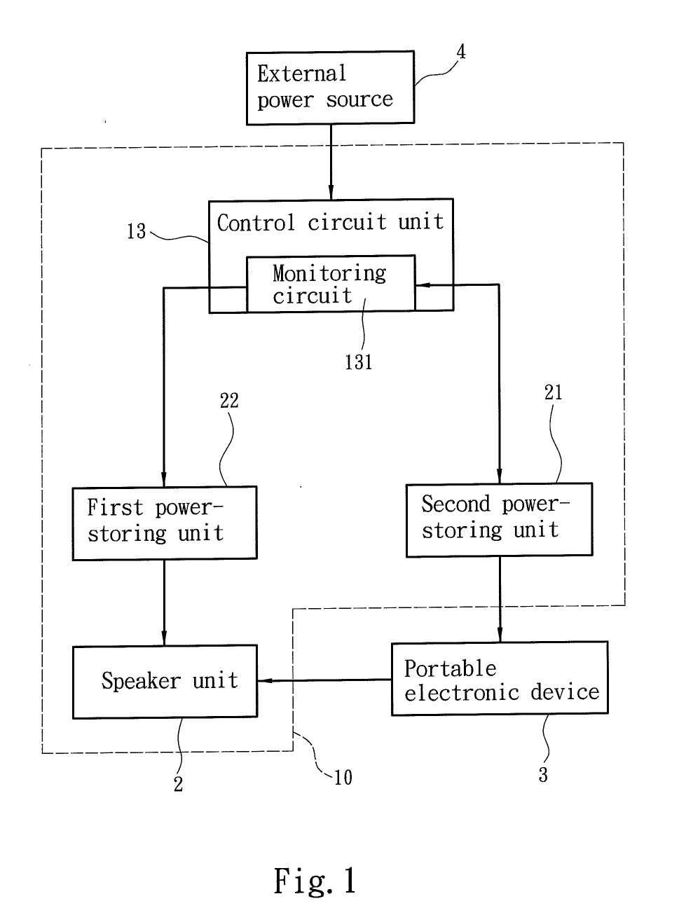

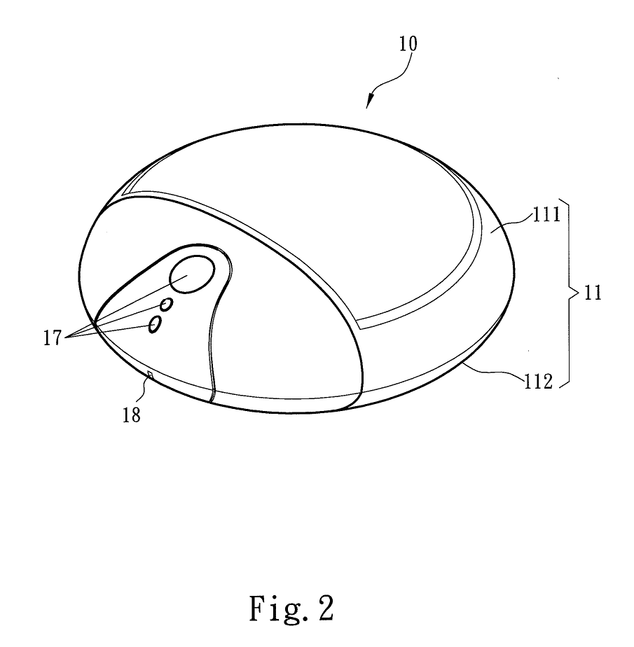

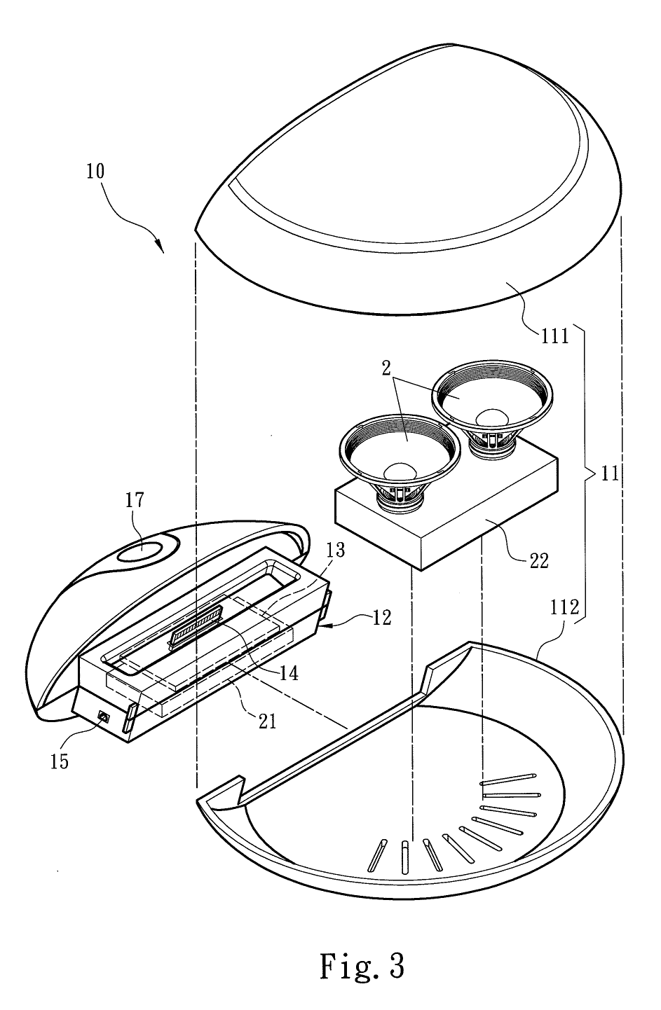

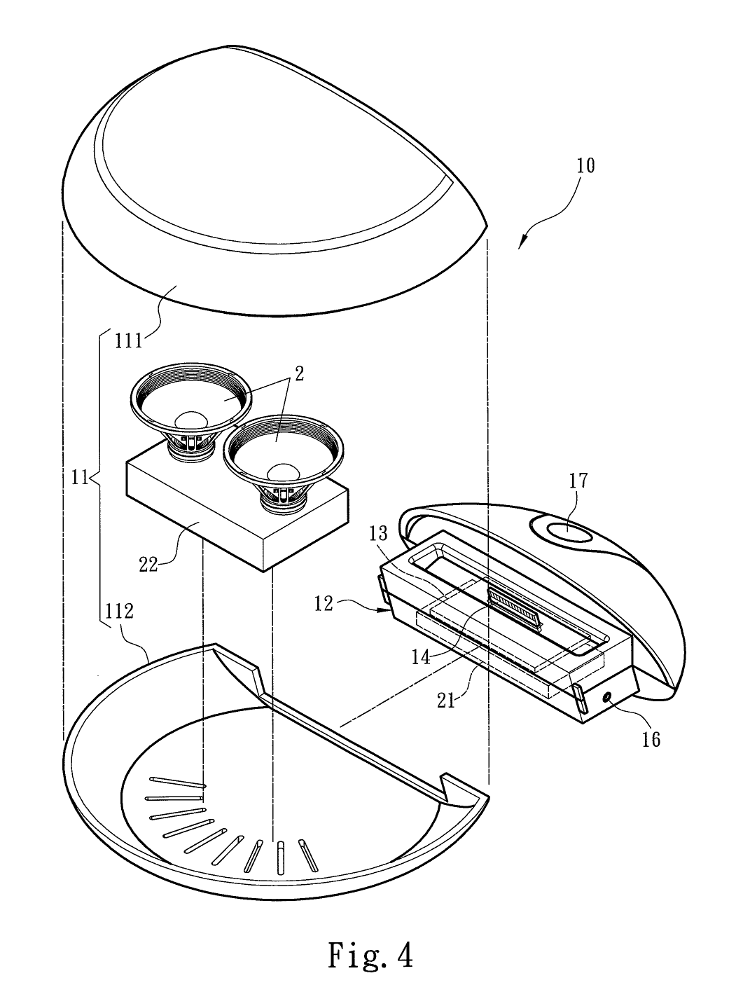

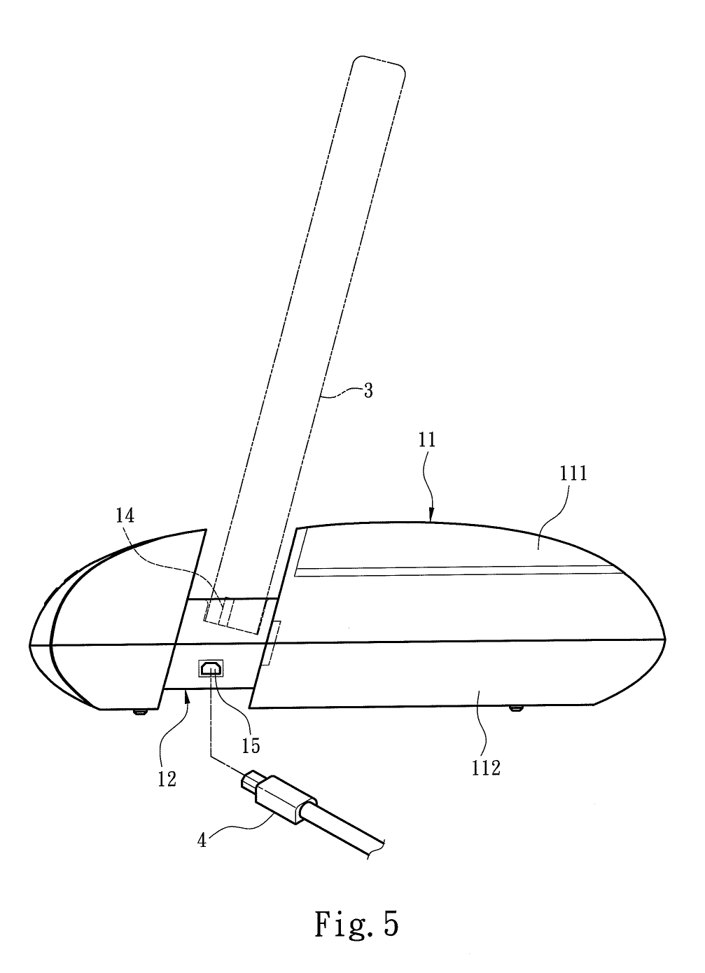

FIG. 1 shows a block diagram of a speaker device providing backup power of the present invention. FIGS. 2, 3 and 4 respectively show a perspective view and exploded views of the speaker device providing backup power of the present invention. Referring to FIGS. 1 to 4, the speaker device of the present invention includes a main body 10 having an internal installation space, at least one speaker unit 2 and at least two power-storing units 21 and 22. The main body 10 includes a charging port 15 for electrically connecting to an external power source 4, an audio port 16 for connecting to a portable electronic device 3 to obtain an audio signal, and a discharging port 14 for electrically connecting to the portable electronic device 3. In the installation space of the main body 10, the main body 10 further includes a control circuit unit 13 connected to the charging port 15, the audio port 16 and the discharging port 14. The at least one speaker unit 2 is disposed in the installation space, and is electrically connected to the control circuit unit 13 to obtain the audio signal of the portable electronic device 3 via the audio port 16. The at least two power-storing units 21 and 22 are disposed in the installation space. The main body 10 includes two half parts 11 and 12. In this embodiment, the speaker unit 2 and the first power-storing unit 22 are disposed in the rear half part 11 formed by two half bodies 111 and 112; the charging port 15, the audio port 16, the discharging port 14, the second power-storing unit 21 and the control circuit unit 13 are disposed in the front half part 12. Further, the first power-storing unit 22 is electrically connected to the control circuit unit 13 to obtain charging power from an external power source 4, and is electrically connected to the speaker unit 2 to drive the speaker unit 2. The second power-storing unit 21 is electrically connected to the discharging port 14, so as to charge the charging power stored in the second power-storing unit 21 into the portable electronic device 3 connected to the discharging port 14.

Referring to FIGS. 1, 3 and 4, in this embodiment, the two half parts 11 and 12 of the main body 10 may be moved relative to each other to form a coupled state and a used state. When a user wishes to charge the first and second storing units 22 and 21 in the speaker device, force is first applied to move the front half part 12 relative to the rear half part 11. With a charging wire (not shown), the external power source 4 and the charging port 15 may be electrically connected to allow the charging power from the external power source 4 to charge the first and second power-storing units 22 and 21 via the charging port 15 and the control circuit unit 13. When a user wants to independently use the speaker device of the present invention as a speaker, the front half part 12 of the main body 10 is moved to a used state. With an audio wire (not shown), the audio port 16 and the portable electronic device 3 may be electrically connected to allow the audio signal played by the portable electronic device 3 to be amplified and played by the speaker unit 2. The main body 10 further includes an operation section 17 for controlling the volume of the speaker unit 2. When a user wants to use the speaker device of the present invention as a backup power device, the front half part 12 of the main body 10 is similarly moved to a used state, and the portable electronic device 3 is inserted to the discharging port 14, so as to allow the second power-storing unit 21 to release charging power originally stored therein to charge the portable electronic device 3 via the control circuit unit 13. Further, the charging port 15 and the discharging port 14 of the present invention may be integrated into one single input/output port. Through the single shared input/output port, the portable electronic device 3 may be charged by the speaker device as by the external power source. That is, the charging process may be performed through a charging wire connecting the portable electronic device 3 and the discharging port 14.

According to the present invention, the control circuit unit 13 further includes a monitoring circuit 131 electrically connected to the first power-storing unit 22 and the second power-storing unit 21. The monitoring circuit 131 includes a power-controlled signal. When an output voltage of the first power-storing unit 21 is lower than a predetermined voltage value, the power-controlled signal of the monitoring circuit 131 prompts the second power-storing unit 21 to charge the first power-storing unit 22. The main body 10 further includes a display section 18. The display section 18 displays a charging status of the second power-storing unit 21 to the portable electronic device 3 or a charging status of the second power-storing unit 21 to the first power-storing unit 22. That is, apart from serving as a backup charging power supply for the portable electronic device 3, the second power-storing unit 21 of the present invention also serves as a backup power supply for the first power-storing unit 22.

In conclusion, by use of the first power-storing unit 22 and the second power-storing unit 21 of the present invention, the portable electronic device 3 and the speaker unit 2 are respectively provided with an independent power supply, thereby eliminating the issue of uneven or unstable power distributed from a same power supply shared by the electronic device and a speaker device as in the prior art. Further, through the second power-storing unit 21 serving as the backup power supply for the first power-storing unit 22, it is ensured that charging power is provided by the second power-storing unit 21 to the first power-storing unit 22 when the first power-storing unit 22 has a power shortage, so as to maintain satisfactory playback effects of the speaker unit 2.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A speaker device providing backup power, comprising:
a main body with an internal installation space, including a charging port for electrically connecting to an external power source, an audio port for connecting to a portable electronic device to obtain an audio signal, a discharging port for electrically connecting to the portable electronic device, and a control circuit unit disposed in the installation space and connected to the charging port, the audio port and the discharging port;
at least one speaker unit, disposed in the installation space and electrically connected to the control circuit unit to obtain the audio signal of the portable electronic device via the audio port; and
at least two power-storing units, disposed in the installation space and electrically connected to the control circuit unit to obtain charging power from the external power source, the at least two power-storing units comprising a first power-storing unit electrically connected to the speaker unit to drive the speaker unit, and a second power-storing unit electrically connected to the discharging port to allow the charging power stored in the second power-storing unit to charge into the portable electronic device connected to the discharging port.

2. The speaker device of claim 1, wherein the control circuit unit further comprises a monitoring circuit electrically connected to the first power-storing unit and the second power-storing unit, and the monitoring circuit comprises a power-controlled signal which prompts the second power-storing unit to charge the first power-storing unit when an output voltage of the first power-storing unit is lower than a predetermined voltage value.

3. The speaker device of claim 1, wherein the main body includes two half parts, and the two half parts move relative to each other to form a coupled state and a used state.

4. The speaker device of claim 1, wherein the main body further comprises an operation section for controlling the speaker unit.

5. The speaker device of claim 1, wherein the main body further comprises a display section for displaying a charging status of the second power-storing unit to the portable electronic device or a charging status of the second power-storing unit to the first power-storing unit.

6. The speaker device of claim 1, wherein the charging port and the discharging port is a single shared input/output port.
